(19) United States
(12) Patent Application Publication
(10) Pub. No.: US 2024/0067856 A1
(43) Pub. Date: Feb. 29, 2024

(54) THERMALLY CONDUCTIVE THERMOPLASTIC COMPOSITE WITH REDUCED PERCOLATION THRESHOLD

(71) Applicant: Ford Global Technologies, LLC, Dearborn, MI (US)

(72) Inventor: Cindy Sofia Barrera-Martinez, Dearborn, MI (US)

(73) Assignee: Ford Global Technologies, LLC, Dearborn, MI (US)

(21) Appl. No.: 17/896,678

(22) Filed: Aug. 26, 2022

(51) Int. Cl. C09K 5/14; C08K 9/02; H01B 3/44

(52) U.S. Cl. CPC C09K 5/14; C08K 9/02; H01B 3/44; C08K 2201/001; C08K 2201/011

(57) ABSTRACT

A thermally conductive, electrically insulating composite material includes a polymer matrix and a continuous network of structural fibers dispersed within the polymer matrix. The continuous network of structural fibers is coated with boron nitride nanoparticles, and the boron nitride nanoparticles are coated onto the continuous network of structural fibers in an amount to reach a thermal percolation threshold of the composite material. The structural fibers may be natural fibers having a cellulose structure.

### FIELD

The present disclosure relates to composite materials, and more particularly to thermally conductive and electrically insulating composite materials.

### BACKGROUND

The statements in this section merely provide background information related to the present disclosure and may not constitute prior art.

In automotive applications, and particularly electric vehicles, the materials that are used balance being lightweight, high strength, and having desired thermal and mechanical properties. In electric vehicles specifically, there is an increasing demand for thermally conductive materials that are also electrically insulating, and in particular for lighting applications, for controlling heat dispersion or as heat sinks for sensors and electronics, for battery components, and for high voltage connectors.

Polymers comprising mineral fillers such as alumina silicates have been used for such electric vehicle components, however these materials do not exhibit desired mechanical properties with a relatively high concentration of filler (i.e., as high as 70 wt. %) needed for thermal conductivity. Using such a high concentration of filler increases the weight of the components, which is especially undesirable for automotive applications. And since filler materials are more expensive than the polymer matrix, the materials are also more expensive.

The present disclosure addresses these and other issues related to the use of thermally conductive and electrically insulating composite materials in a variety of applications, including electric vehicles.

### SUMMARY

This section provides a general summary of the disclosure and is not a comprehensive disclosure of its full scope or all of its features.

According to one form of the present disclosure, a thermally conductive, electrically insulating composite material comprises a polymer matrix and a continuous network of structural fibers dispersed within the polymer matrix. The continuous network of structural fibers is coated with boron nitride nanoparticles, and the boron nitride nanoparticles are coated onto the continuous network of structural fibers in an amount to reach a thermal percolation threshold of the composite material.

In variations of this form, which may be implemented individually or in any combination: the structural fibers comprise natural fibers having a cellulose structure; the natural fibers are selected from the group consisting of jute, flax, hemp, agave, and wood fiber; the structural fibers have an aspect ratio greater than about 100; the structural fibers are discontinuous; the structural fibers are micro-scale in length; the structural fibers comprise an additive; the additive comprises a coupling agent; the boron nitride nanoparticles are in a form of platelets; the polymer matrix comprises a thermoplastic; and a part for a vehicle comprises the composite material.

According to another form of the present disclosure, a thermally conductive, electrically insulating composite material comprises a polymer matrix and a continuous network of structural fillers comprising natural fibers dispersed within the polymer matrix. The natural fibers have a cellulose structure and are coated with boron nitride nanoparticles. The boron nitride nanoparticles are coated onto the natural fibers in an amount to reach a thermal percolation threshold of the composite material.

In variations of this form, which may be implemented individually or in any combination: the natural fibers have an aspect ratio greater than about 100; the natural fibers are discontinuous; the natural fibers are micro-scale in length; and the boron nitride nanoparticles are in a form of platelets.

According to yet another form of the present disclosure, a thermally conductive, electrically insulating composite material comprises a thermoplastic polymer matrix and a continuous network of structural fillers consisting of natural fibers having a cellulose structure and being coated with boron nitride nanoparticles. The boron nitride nanoparticles are coated onto the natural fibers in an amount to reach a thermal percolation threshold of the composite material.

In variations of this form, which may be implemented individually or in any combination: the natural fibers have an aspect ratio greater than about 100; the natural fibers are micro-scale in length; and the boron nitride nanoparticles are in a form of platelets.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a composite material constructed according to the present disclosure;

FIG. 2 includes graphs illustrating preliminary mechanical test data comparing boron nitride reinforced polypropylene to unreinforced polypropylene;

FIG. 3 includes graphs illustrating preliminary mechanical test data comparing boron nitride reinforced polyamide to unreinforced polyamide;

FIG. 4A includes a graph illustrating preliminary thermal test data comparing boron nitride reinforced polypropylene to unreinforced polypropylene; and

FIG. 4B includes graphs illustrating preliminary thermal test data comparing boron nitride reinforced polyamide to unreinforced polyamide.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a lightweight, high strength composite material which exhibits thermal conductivity, electrical insulation, and improved mechanical properties. More specifically, the inventors have discovered a unique composite material with a filler that reaches a thermal percolation threshold of the composite material to be thermally conductive, while maintaining electrical insulation properties and improved mechanical properties versus solutions of the prior art. As used here, the term “thermal percolation threshold” should be construed to mean an amount of filler at which the thermal conductivity of the composite material increases rapidly by several orders of magnitude, thereby transitioning the composite material to being thermally conductive from a state of being thermally nonconductive.

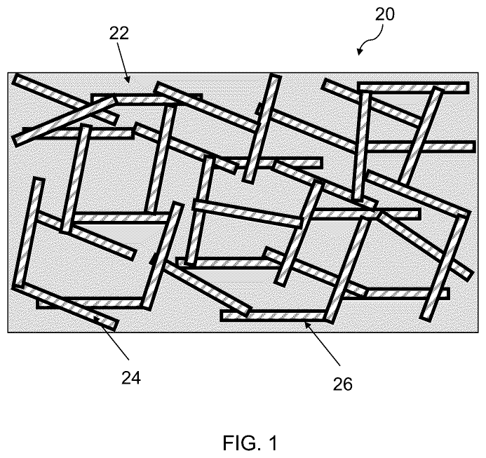

Referring to FIG. 1, a composite material 20 comprises a polymer matrix 22 and a continuous network of structural fibers 24 dispersed within the polymer matrix 22. The polymer matrix 22 may be a thermoplastic material such as polypropylene or a polyamide (PA-6) by way of example, however the present disclosure is not limited thereto. The polymer matrix 22 may include other thermoplastic materials or thermoset materials while remaining within the scope of the present disclosure.

Advantageously, the continuous network of structural fibers 24 are coated with boron nitride nanoparticles 26 in an amount to reach a thermal percolation threshold of the composite material 20. Accordingly, the continuous network of structural fibers 24 coated with the coated boron nitride nanoparticles 26 generally provides the requisite thermal conductivity to the composite material 20, and advantageously also provides reinforcements to improve the mechanical properties of the composite material 20. As used herein, “continuous network” means that the structural fibers 24 are in close proximity to each other and/or are touching each other so as to provide a path or continuity for thermal conductivity properties as set forth in greater detail below. It should be understood that direct contact between the continuous network of structural fibers 24 is not necessary in order to reach the thermal percolation threshold.

The continuous network of structural fibers 24 in one form are natural fibers having a cellulose structure. By way of nonlimiting example, the natural fibers may include jute, flax, hemp, agave, or wood fiber, among others. Natural fibers exhibit desired mechanical properties, have high specific surface area, and also have a relatively low density. Natural fibers are also low cost, highly availability, and environmentally sustainable, which makes them desirable for automotive applications, or other high volume applications, on a large production scale.

The structural fibers 24 in one form have an aspect ratio greater than about 100. (The “aspect ratio” is defined herein as the length of a fiber divided by an average width or diameter). With this relatively high aspect ratio, the amount of boron nitride nanoparticles 26 that are required to meet the thermal percolation threshold is greatly reduced. More specifically, the high aspect ratio creates a topology of the continuous network of structural fibers 24 that allows the boron nitride nanoparticles 26 to be attached and dispersed more effectively. Further, the structural fibers 24 micro-scale in length, or under about 1 mm. And as further shown, the structural fibers 24 are discontinuous, however, it should be understood that the structural fibers 24 may be continuous throughout the polymer matrix 22 while remaining within the scope of the present disclosure.

The boron nitride nanoparticles 26 in one form of the present disclosure are in the form of platelets. However, it should be understood that other shape forms of nanoparticles may be employed, such as by way of example, flakes. Generally, the boron nitride nanoparticles 26 are coated onto the continuous network of structural fibers 24 by surface treating the structural fibers 24 and coupling the boron nitride on the surface of the structural fibers. By way of non-limiting example, the surface treating of the structural fibers 24 may comprise alkali treating the structural fibers 24 to expose functional groups (i.e., OH groups) which bind to functional groups on the boron nitride nanoparticles, which have been acid treated. However, it should be understood that other surface treatments are contemplated without deviating from the scope of the present disclosure.

The composite material 20 optionally comprises an additive such as, for example, a coupling agent. The coupling agent strengthens the interphase between the polymer matrix 22, the continuous network of structural fibers 24, and the boron nitride nanoparticles 26. Additional additives, such as thermal stabilizers, light stabilizers, colorants, and antioxidants, among others, may also be added to the composite material 20 as specific application requirements dictate.

Test Data

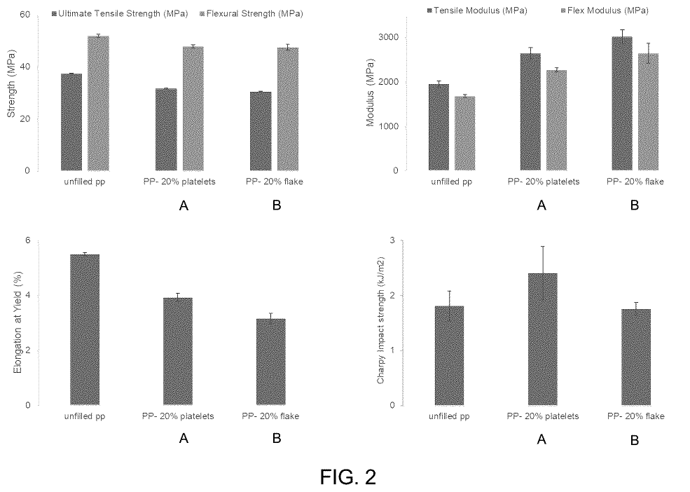

Referring to FIGS. 2-4B, both mechanical and thermal testing was conducted on boron nitride reinforced polypropylene and polyamide (PA-6) and compared with unreinforced polypropylene and polyamide (PA-6).

FIG. 2 illustrates the differences in mechanical properties between boron nitride reinforced polypropylene and unreinforced polypropylene. More specifically, a polypropylene polymer matrix was reinforced with 20 wt. % of boron nitride nanoparticles. In column A, the boron nitride nanoparticles were in the form of platelets, and in column B, the boron nitride nanoparticles were in the form of flakes. As shown, the reinforced polypropylene demonstrated a decrease in tensile and flexural strength, which was similar for both flakes and platelets. However, tensile and flexural modulus were increased with boron nitride reinforcement, while elongation decreased. The Charpy impact strength increased only with the addition of boron nitride nanoparticles being in the form of platelets.

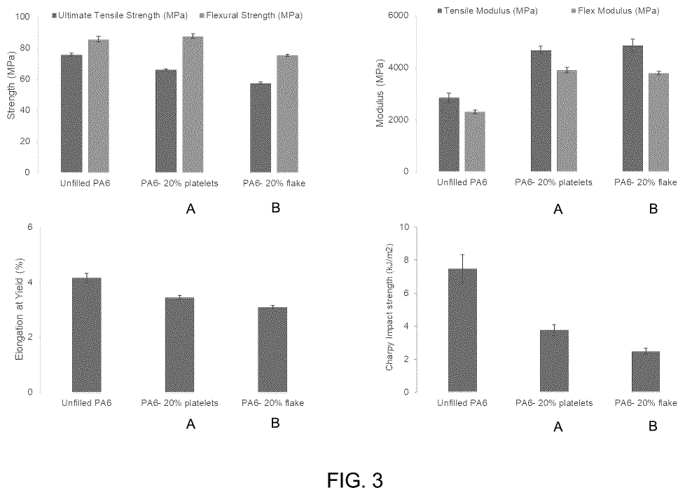

FIG. 3 illustrates the differences in mechanical properties between boron nitride reinforced polyamide (PA-6) and unreinforced polyamide (PA-6). More specifically, a polyamide (PA-6) polymer matrix was reinforced with 20 wt. % of boron nitride nanoparticles. In column A, the boron nitride nanoparticles were in the form of platelets, and in column B, the boron nitride nanoparticles were in the form of flakes. As shown, the reinforced polyamide (PA-6) demonstrated a decrease in tensile strength for both flakes and platelets and in flexural strength for flakes, and demonstrated a slight increase in flexural strength for platelets. However, tensile and flexural modulus were increased with boron nitride reinforcement, while elongation decreased. The Charpy impact strength decreased with the addition of boron nitride nanoparticles being in the form of platelets and of flakes.

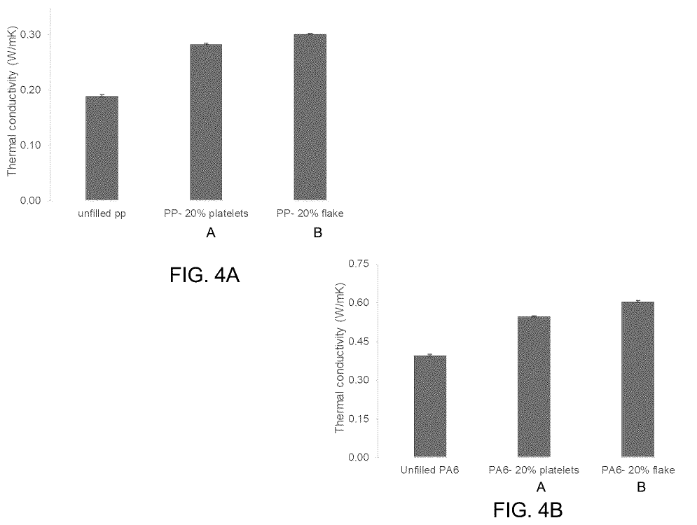

FIG. 4A illustrates the differences in thermal conductivity between boron nitride reinforced polypropylene and unreinforced polypropylene. More specifically, a polypropylene polymer matrix was reinforced with 20 wt. % of boron nitride nanoparticles. In column A, the boron nitride nanoparticles were in the form of platelets, and in column B, the boron nitride nanoparticles were in the form of flakes. As shown, the reinforced polypropylene demonstrated an increase in thermal conductivity for both flakes and platelets.

FIG. 4B illustrates the differences in thermal conductivity between boron nitride reinforced polyamide (PA-6) and unreinforced polyamide (PA-6). More specifically, a polyamide (PA-6) polymer matrix was reinforced with 20 wt. % of boron nitride nanoparticles. In column A, the boron nitride nanoparticles were in the form of platelets, and in column B, the boron nitride nanoparticles were in the form of flakes. As shown, the reinforced polyamide (PA-6) demonstrated an increase in thermal conductivity for both flakes and platelets.

Composites having mineral fillers, such as alumina silicates, can achieve thermal conductivity up to about 1.15 W/m·K. The composite material 20 according to the present disclosure can achieve thermal conductivity about four times higher, i.e., about 4.60 W/m·K, with higher amounts of structural fibers coated with boron nitride nanoparticles. Furthermore, while mineral fillers can provide some, albeit low, level of thermal conductivity even at concentrations up to 70 wt. %, they provide little to no structural reinforcement and can even undesirably affect the mechanical properties of the composite material.

Compared to conventional composite materials which comprise a filler alone dispersed with a matrix, the continuous network of structural fibers 24 being coated with boron nitride nanoparticles 26 provides improved dispersion of the boron nitride nanoparticles 26 within the polymer matrix 22. In addition, the continuous network of structural fibers 24 allows for use of less filler (i.e., boron nitride nanoparticles 26) while still providing the desired properties of the composite material.

The composite material according to the present disclosure can be used to produce motor vehicle parts such as heat sinks for lighting systems, high voltage connectors (i.e., about 480V) and terminals for electric vehicles, and thermal plates, among others, for electric vehicles.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A thermally conductive, electrically insulating composite material, the composite material comprising:
a polymer matrix; and
a continuous network of structural fibers dispersed within the polymer matrix, the continuous network of structural fibers being coated with boron nitride nanoparticles,
wherein the boron nitride nanoparticles are coated onto the continuous network of structural fibers in an amount to reach a thermal percolation threshold of the composite material.

2. The composite material according to claim 1, wherein the structural fibers comprise natural fibers having a cellulose structure.

3. The composite material according to claim 2, wherein the natural fibers are selected from the group consisting of jute, flax, hemp, agave, and wood fiber.

4. The composite material according to claim 1, wherein the structural fibers have an aspect ratio greater than about 100.

5. The composite material according to claim 1, wherein the structural fibers are discontinuous.

6. The composite material according to claim 1, wherein the structural fibers are micro-scale in length.

7. The composite material according to claim 1, wherein the structural fibers comprise an additive.

8. The composite material according to claim 7, wherein the additive comprises a coupling agent.

9. The composite material according to claim 1, wherein the boron nitride nanoparticles are in a form of platelets.

10. The composite material according to claim 1, wherein the polymer matrix comprises a thermoplastic.

11. A part, the part comprising the composite material according to claim 1.

12. A thermally conductive, electrically insulating composite material, the composite material comprising:
a polymer matrix; and
a continuous network of structural fillers comprising natural fibers dispersed within the polymer matrix, the natural fibers having a cellulose structure and being coated with boron nitride nanoparticles,
wherein the boron nitride nanoparticles are coated onto the natural fibers in an amount to reach a thermal percolation threshold of the composite material.

13. The composite material according to claim 12, wherein the natural fibers have an aspect ratio greater than about 100.

14. The composite material according to claim 12, wherein the natural fibers are discontinuous.

15. The composite material according to claim 12, wherein the natural fibers are micro-scale in length.

16. The composite material according to claim 12, wherein the boron nitride nanoparticles are in a form of platelets.

17. A thermally conductive, electrically insulating composite material, the composite material comprising:
a thermoplastic polymer matrix; and
a continuous network of structural fillers consisting of natural fibers having a cellulose structure and being coated with boron nitride nanoparticles,
wherein the boron nitride nanoparticles are coated onto the natural fibers in an amount to reach a thermal percolation threshold of the composite material.

18. The composite material according to claim 17, wherein the natural fibers have an aspect ratio greater than about 100.

19. The composite material according to claim 17, wherein the natural fibers are micro-scale in length.

20. The composite material according to claim 17, wherein the boron nitride nanoparticles are in a form of platelets.
